(19) United States
(12) Patent Application Publication
(10) Pub. No.: US 2026/0361036 A1
(43) Pub. Date: Nov. 12, 2026

(54) HIGH-SPEED CONNECTOR

(71) Applicant: BIZLINK INTERNATIONAL CORP., New Taipei City (TW)

(72) Inventors: Kaiwen ZHENG, New Taipei City (TW); Chin-An HSIEH, New Taipei City (TW)

(21) Appl. No.: 19/660,268

(22) Filed: Apr. 28, 2026

(30) Foreign Application Priority Data
May 9, 2025 (TW) 114117609

(51) Int. Cl. H01R 13/6597; H01R 12/72

(52) U.S. Cl. CPC H01R 13/6597; H01R 12/721

(57) ABSTRACT

A high-speed connector includes a housing, a signal terminal, a ground terminal, and a ground plate. The housing includes an opening, wherein the opening defines an insertion direction. The signal terminal is accommodated within the housing. The ground terminal is accommodated within the housing and includes a first ground path and a first ground contact point corresponding to the first ground path and the insertion direction. The ground plate is accommodated within the housing and includes a second ground path and a second ground contact point corresponding to the second ground path and the insertion direction, wherein the first ground contact point and the second ground contact point are spaced apart along the insertion direction.

### CROSS - REFERENCE TO RELATED APPLICATION

This application claims priority to Taiwan Application Serial Number 114117609, filed May 09, 2025, which is herein incorporated by reference in its entirety.

### BACKGROUND

### Field of Invention

The present invention relates to a connector. More particularly, the present invention relates to a high-speed connector.

### Description of Related Art

High-speed connectors are typically used to transmit high-frequency signals, such as in data communications, computer networks, and high-speed digital circuits. Since high-frequency signals have shorter wavelengths, high-speed connectors are more susceptible to surrounding electromagnetic fields during transmission, making them highly sensitive to interference.

The published prior art (CN111490380B) discloses an electrical connector that includes terminals. However, the ground path of the terminals in this prior art is limited, resulting in poor performance in mitigating signal interference.

Therefore, providing a connector capable of establishing a reliable electrical connection, preventing electromagnetic interference, and ensuring accurate signal transmission remains a significant challenge in the field.

### SUMMARY

To solve the aforementioned problems, the present disclosure provides a high-speed connector including a housing, a signal terminal, a ground terminal, and a ground plate. The housing includes an opening, wherein the opening defines an insertion direction. The signal terminal is accommodated within the housing. The ground terminal is accommodated within the housing and includes a first ground path and a first ground contact point corresponding to the first ground path and the insertion direction. The ground plate is accommodated within the housing and includes a second ground path and a second ground contact point corresponding to the second ground path and the insertion direction, wherein the first ground contact point and the second ground contact point are spaced apart along the insertion direction.

Another aspect of the present disclosure provides a high-speed connector including a housing, a signal terminal, and a ground terminal. The housing includes an opening, wherein the opening defines an insertion direction. The signal terminal is accommodated within the housing. The ground terminal is accommodated within the housing and includes a first ground path, a second ground path, a first ground contact point corresponding to the first ground path and the insertion direction, and a second ground contact point corresponding to the second ground path and the insertion direction, wherein the first ground contact point and the second ground contact point are spaced apart along the insertion direction.

Another aspect of the present disclosure provides a high-speed connector including a housing, at least one signal terminal, at least one ground terminal, and a ground plate. The housing has an opening, and the opening defines an insertion direction. The signal terminal is accommodated within the housing. The ground terminal is accommodated within the housing. The ground plate is accommodated within the housing, and the ground plate includes at least one first micro-pin structure and at least one second micro-pin structure. The first micro-pin structure extends away from the ground terminal, and the second micro-pin structure extends toward the ground terminal.

The high-speed connector of the present disclosure provides superior performance. The signal terminal accommodated in the housing supports high-speed data transmission, while the ground terminal and the ground plate respectively provide the first and second ground paths. Through the first and second ground contact points spaced apart along the insertion direction, a stable grounding function is realized, thereby effectively suppressing electromagnetic interference and enhancing signal integrity. This design integrates the advantages of dual grounding and a flexible layout to ensure low noise and high signal quality, which is particularly suitable for the requirements of modern electronic devices for efficient data processing and reliable connections.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a schematic perspective view of a high-speed connector in accordance with some embodiments of the present disclosure.

FIG. 2 is a schematic side view of the high-speed connector in FIG. 1.

FIG. 3 is a partially enlarged view of the high-speed connector in FIG. 1.

FIG. 4 is a schematic perspective view of a high-speed connector in accordance with some other embodiments of the present disclosure.

FIG. 5 is a schematic side view of the high-speed connector in FIG. 4.

FIG. 6 is a partially enlarged view of the high-speed connector in FIG. 4.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

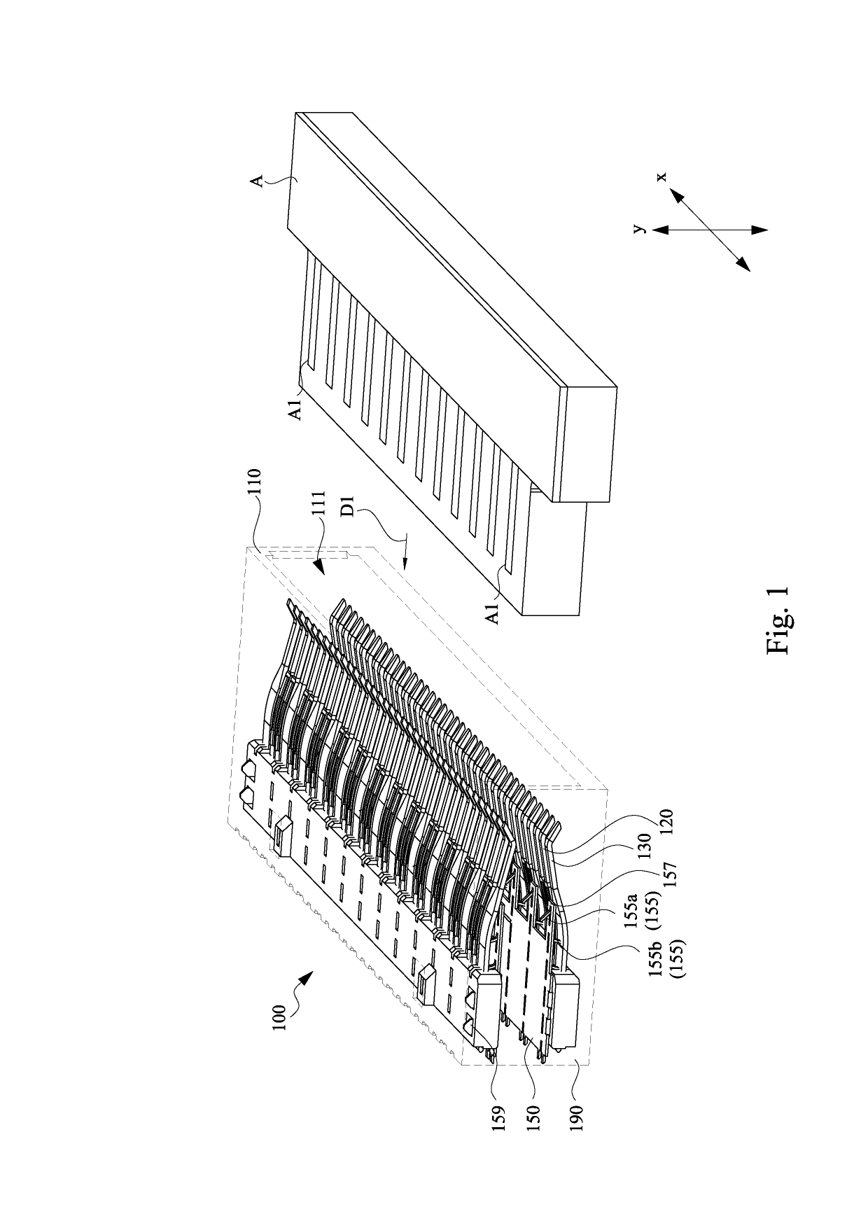

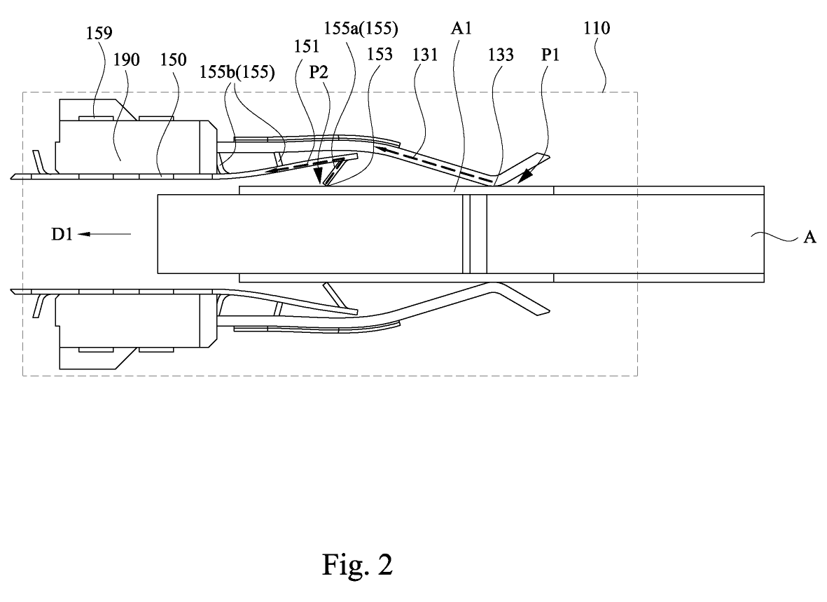

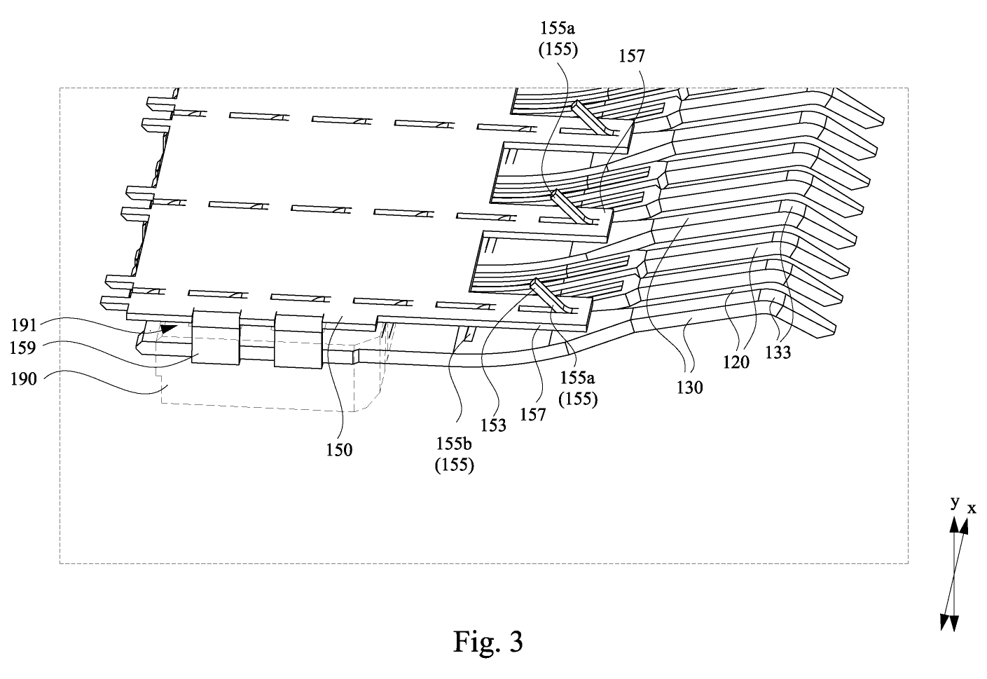

Please refer to FIGS. 1-3. FIGS. 1-3. illustrate a high-speed connector 100 of the present disclosure, which can be applied, for example, in the field of artificial intelligence servers. In some embodiments of the present disclosure, the high-speed connector 100 includes a housing 110, a signal terminal 120, a ground terminal 130, and a ground plate 150, and the high-speed connector 100 can receive an electronic component carrier A for cooperative use.

The housing 110 is a shell structure mainly used to support and protect internal components from external damage, and the housing 110 includes an opening 111 which can define an insertion direction D1 as: "the direction pointing from the opening 111 to the inside of the housing 110," so that the electronic component carrier A can at least partially enter the housing 110 from the opening 111 along the insertion direction D1. It should be noted that the housing 110 is either omitted or depicted in dashed lines to reveal the internal components, and the insertion direction D1 can be perpendicular to a horizontal direction X and a vertical direction Y shown in FIGS. 1-3.

The signal terminal 120 is a conductive element for transmitting data signals and is made of a conductive material (e.g., copper alloy).

The ground terminal 130 provides a stable potential reference for the high-speed connector 100, and the ground terminal 130 is disposed on one side of the signal terminal 120 in the horizontal direction X. The ground terminal 130 is made of a conductive material (e.g., copper alloy).

The ground plate 150 may connect to one or more ground terminals 130, and the ground plate 150 ensures that all ground terminals 130 electrically connected to the ground plate 150 within the high-speed connector 100 have a consistent potential reference. The ground plate 150 is made of a conductive material (e.g., copper alloy).

The electronic component carrier A may be a circuit board (e.g., a double-sided printed circuit board, a multilayer circuit board, a rigid circuit board, or a flexible circuit board).

Please refer to FIGS. 1-3. The signal terminal 120 and the ground terminal 130 of the high-speed connector 100 are accommodated within the housing 110, and the ground terminal 130 includes a first ground path 131 and a first ground contact point 133 which corresponds to the first ground path 131 and the insertion direction D1, and the first ground contact point 133 is configured to electrically contact a conductive element A1 (e.g., conductive pad of printed circuit board or paddle card) on the electronic component carrier A. In practical applications, when the electronic component carrier A is inserted into the housing 110 along the insertion direction D1, the conductive element A1 electrically contacts the first ground contact point 133 at a first position P1. This connects the conductive element A1 to the first ground path 131 and further to the system's ground reference point, thereby ensuring a stable zero-potential reference. Specifically, "the first ground contact point 133 corresponding to the first ground path 131 and the insertion direction D1" can be interpreted as "the first ground contact point 133 is the starting point of the first ground path 131" and "the position of the first ground contact point 133 is related to the position where the electronic component carrier A contacts the ground terminal 130 after being inserted into the housing 110 along the insertion direction D1".

In addition, the ground plate 150 is accommodated within the housing 110 and includes a second ground path 151 and a second ground contact point 153 which corresponds to the second ground path 151 and the insertion direction D1. Specifically, when the electronic component carrier A is inserted into the housing 110 along the insertion direction D1, the conductive element A1 electrically contacts the second ground contact point 153 of the ground plate 150 at a second position P2. Consequently, the conductive element A1 is connected to the system's ground reference point via the second ground path 151, thereby ensuring a stable zero-potential reference. In some embodiments of the present disclosure, "the second ground contact point 153 corresponding to the second ground path 151 and the insertion direction D1" can be interpreted as "the second ground contact point 153 is the starting point of the second ground path 151" and "the position of the second ground contact point 153 is related to the position where the electronic component carrier A contacts the ground plate 150 after being inserted into the housing 110 along the insertion direction D1".

In addition, since the first ground contact point 133 and the second ground contact point 153 are spaced apart along the insertion direction D1, the conductive element A1 can be simultaneously electrically connected to the first ground path 131 and the second ground path 151. Therefore, the present disclosure provides a multi-path grounding structure with excellent grounding performance, which is particularly suitable for the field of artificial intelligence servers with high grounding requirements.

Please refer to FIGS. 1-3. In some embodiments of the present disclosure, the ground plate 150 includes a micro-pin structure 155, and a stamping process (e.g., a U-shaped head stamping process) can be applied to the ground plate 150 to manufacture the micro-pin structure 155.

Specifically, a free end of the micro-pin structure 155 is configured to electrically contact the conductive element A1, and the second ground contact point 153 is disposed at the free end of the micro-pin structure 155. The design of the micro-pin structure 155 provides the ground plate 150 with greater spatial flexibility to electrically contact the conductive element A1 in three-dimensional space, thereby improving the connection flexibility and grounding efficiency between the ground plate 150 and the conductive element A1. In some embodiments, the micro-pin structure 155 is made of elastic material, such as elastic alloy. When the electronic component carrier A is inserted into the high-speed connector 100, the micro-pin structure 155 undergoes an elastic deformation to apply a normal force against the conductive element A1, thereby ensuring a reliable and continuous electrical connection.

Please refer to FIGS. 1-3. In some embodiments of the present disclosure, the ground plate 150 includes an extension arm 157, and the extension arm 157 may be a substantially rectangular sheet structure made by a cutting process.

In some embodiments of the present disclosure, the ground terminal 130 is disposed on one side of the signal terminal 120 in the horizontal direction X, and the extension arm 157 is immediately adjacent to and disposed above the ground terminal 130. In other words, the extension arm 157 is located on one side of the ground terminal 130 in the vertical direction Y. Accordingly, the ground terminal 130 and the extension arm 157 collectively form a multi-dimensional electromagnetic shielding structure, which effectively mitigates electromagnetic interference affecting the signal terminal 120.

In some embodiments of the present disclosure, the high-speed connector 100 includes two ground terminals 130, and the ground plate 150 includes two extension arms 157. The two ground terminals 130 are respectively disposed on opposite sides of the signal terminal 120 in the horizontal direction X, and the two extension arms 157 are respectively disposed above the two ground terminals 130 (e.g., at one side in the vertical direction Y). Therefore, the two ground terminals 130 and the two extension arms 157 can comprehensively form a multi-dimensional electromagnetic shielding structure to protect the signal terminal 120 from electromagnetic interference.

In some embodiments of the present disclosure, the extension arm 157 is disposed on one side of the signal terminal 120 in the horizontal direction X, and the micro-pin structure 155 is disposed on the extension arm 157. The micro-pin structure 155 extends from the extension arm 157 along the vertical direction Y, and the micro-pin structure 155 and the extension arm 157 can protect the signal terminal 120 from electromagnetic interference in multiple directions, thereby mitigating electromagnetic interference and signal distortion.

In some embodiments of the present disclosure, the ground plate 150 further includes a first micro-pin structure 155a and a second micro-pin structure 155b, and the first micro-pin structure 155a and the second micro-pin structure 155b respectively extend from the ground plate 150 along different directions. Specifically, the first micro-pin structure 155a and the second micro-pin structure 155b respectively extend from the extension arm 157 along opposite directions in the vertical direction Y. However, the first micro-pin structure 155a and the second micro-pin structure 155b may also extend from the main body of the ground plate 150 and respectively extend along opposite directions in the vertical direction Y. Since the first micro-pin structure 155a and the second micro-pin structure 155b extend along multiple directions to provide multiple functions (e.g., the first micro-pin structure 155a can electrically contact the electronic component carrier A, and the second micro-pin structure 155b is used to shield electromagnetic waves), they have considerable adaptability and can be applied to electronic component carriers A of different specifications.

In some embodiments of the present disclosure, the first micro-pin structure 155a extends away from the underlying ground terminal 130, and a plurality of second micro-pin structures 155b extend toward the underlying ground terminal 130 and connect to the ground terminal 130. The ground terminal 130, the first micro-pin structure 155a, and the plurality of second micro-pin structures 155b collectively form a multi-dimensional electromagnetic shielding structure to protect the signal terminal 120 from electromagnetic interference. Specifically, the ground plate 150 includes multiple rows of second micro-pin structures 155b, and each row includes three to seven second micro-pin structures 155b. The second micro-pin structures 155b in each row are arranged at equal intervals.

In some embodiments of the present disclosure, two ground terminals 130 are respectively disposed on opposite sides of the signal terminal 120 in the horizontal direction X, and two rows of second micro-pin structures 155b on the ground plate 150 respectively extend toward the two ground terminals 130 below and connect to the ground terminals 130. Thereby, the two ground terminals 130, the ground plate 150, and the two rows of second micro-pin structures 155b collectively form a three-dimensional electromagnetic shielding structure surrounding the signal terminal 120.

Please refer to FIGS. 1-3 . The high-speed connector 100 further includes a fastening component 190, and the fastening component 190 is disposed and fixed within the housing 110. In addition, the ground plate 150 further has a fixing arm 159 extending through a through hole 191 of the fastening component 190 and bending vertically. The fixing arm 159 is inserted into and fixed to the fastening component 190, and the ground plate 150 is firmly installed within the housing 110.

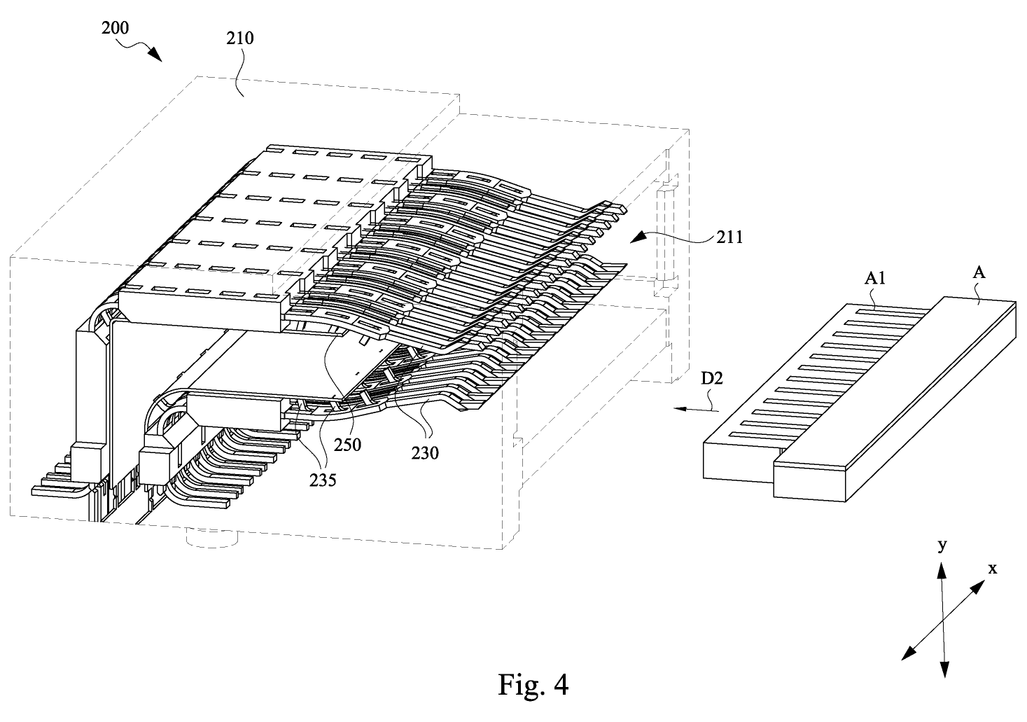

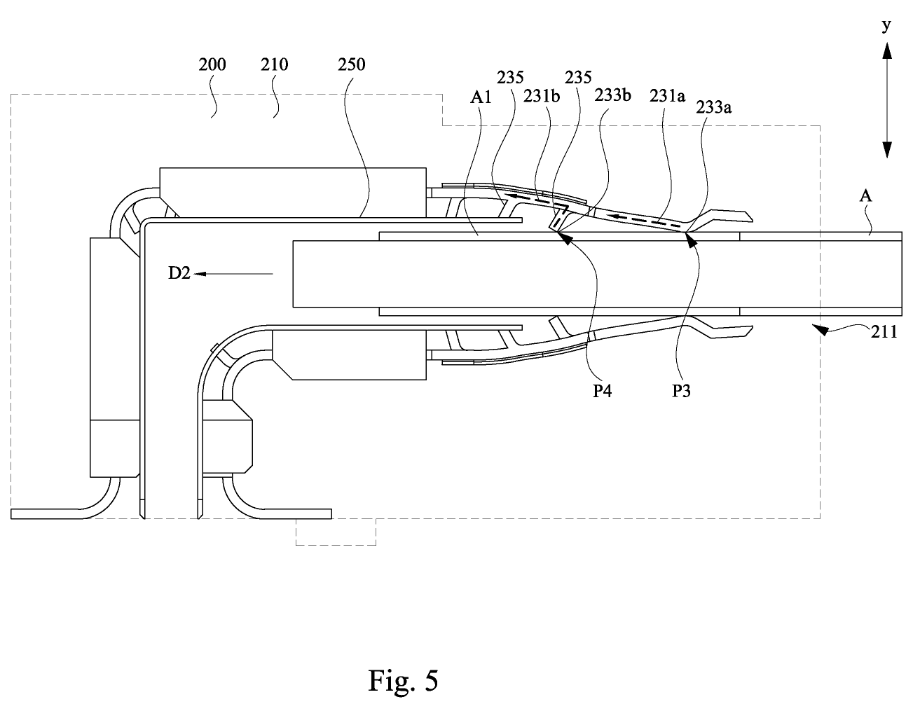

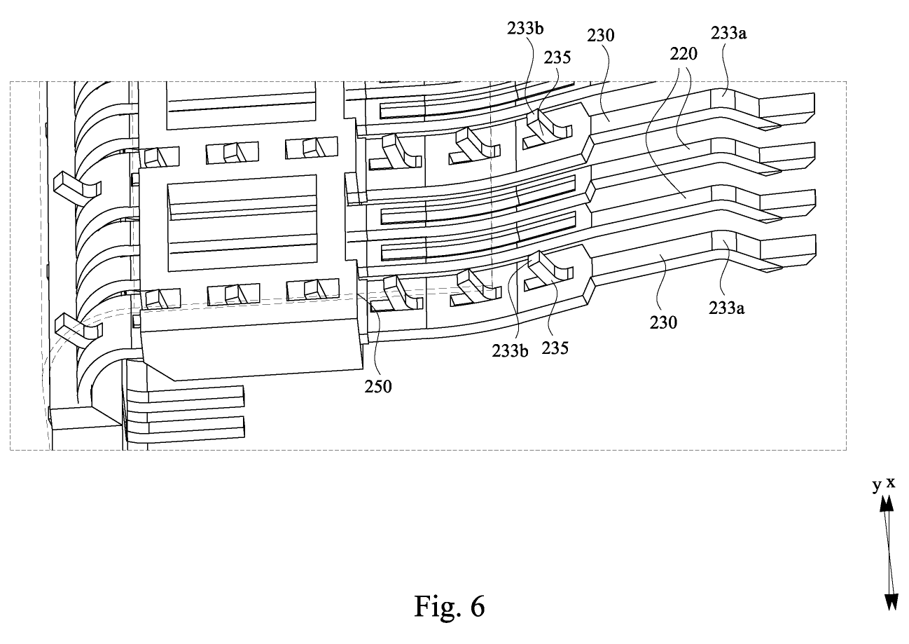

Please refer to FIGS. 4-6. In other embodiments of the present disclosure, the high-speed connector 200 includes a housing 210, a signal terminal 220, a ground terminal 230, and a ground plate 250. The housing 210 and the signal terminal 220 are substantially the same as the housing 110 and the signal terminal 120 of the high-speed connector 100 (please refer to FIGS. 1-3). In addition, the electronic component carrier A can partially enter the housing 210 from an opening 211 of the housing 210 along an insertion direction D2, which is perpendicular to a horizontal direction X and a vertical direction Y. The functions of the ground terminal 230 and the ground plate 250 are substantially the same as those of the ground terminal 130 and the ground plate 150 (please refer to FIGS. 1-3), and specific differences will be described below. It should be noted that the housing 210 is indicated by dashed lines to indicate its transparent state or is omitted for observation of its internal components.

Specifically, the ground terminal 230 is accommodated within the housing 210 and includes a first ground path 231a, a second ground path 231b, a first ground contact point 233a, and a second ground contact point 233b. The first ground contact point 233a corresponds to the first ground path 231a and the insertion direction D2, and the second ground contact point 233b corresponds to the second ground path 231b and the insertion direction D2. The first ground contact point 233a and the second ground contact point 233b are spaced apart along the insertion direction D2. Therefore, the ground terminal 230 has the first ground path 231a and the second ground path 231b for electrically connecting the conductive element A1, which provides a multi-path grounding structure and has excellent grounding performance, and thus the ground terminal 230 is particularly suitable for the field of artificial intelligence servers with high grounding requirements. In some embodiments of the present disclosure, "the first ground contact point 233a corresponds to the first ground path 231a and the insertion direction D2" can be interpreted as "the first ground contact point 233a is the starting point of the first ground path 231a" and "the position of the first ground contact point 233a is related to the position where the electronic component carrier A contacts the conductive element A1 after being inserted into the housing 210 along the insertion direction D2". In addition, "the second ground contact point 233b corresponds to the second ground path 231b and the insertion direction D2" can be interpreted as "the second ground contact point 233b is the starting point of the second ground path 231b" and "the position of the second ground contact point 233b is related to the position where the electronic component carrier A contacts the conductive element A1 after being inserted into the housing 210 along the insertion direction D2".

In practical applications, after the electronic component carrier A is inserted into the housing 210 along the insertion direction D2, the conductive element A1 on the electronic component carrier A electrically connects to the first ground contact point 233a and the second ground contact point 233b of the ground terminal 230 at a third position P3 and a fourth position P4. Through electrical contact with the conductive element A1, the first ground contact point 233a and the second ground contact point 233b route the potential of the electronic component carrier A to the ground terminal 230 and the ground plate 250 connected to the ground terminal 230.

In some embodiments of the present disclosure, the ground terminal 230 includes a micro-pin structure 235, and a stamping process (e.g., a U-shaped head stamping process) can be applied to the ground terminal 230 to manufacture the micro-pin structure 235.

Specifically, the micro-pin structure 235 extends from the main body of the ground terminal 230 along the vertical direction Y, and the second ground contact point 233b is located on the micro-pin structure 235. The design of the micro-pin structure 235 enables the ground terminal 230 to flexibly electrically contact the conductive element A1 in three-dimensional space, thereby improving the accuracy of the electrical contact and grounding efficiency. In some embodiments, the micro-pin structure 235 is made of elastic material, such as elastic alloy. When the electronic component carrier A is inserted into the high-speed connector 200, the micro-pin structure 235 undergoes an elastic deformation to apply a normal force against the conductive element A1, thereby ensuring a reliable and continuous electrical connection.

In some embodiments of the present disclosure, the ground terminal 230 is disposed on one side of the signal terminal 220 in the horizontal direction X, and the ground terminal 230 includes a plurality of micro-pin structures 235 extending from the main body of the ground terminal 230 along the vertical direction Y. The plurality of micro-pin structures 235 (e.g., three to seven micro-pin structures 235) are arranged in a straight row at equal intervals. The main body of the ground terminal 230 and the plurality of micro-pin structures 235 collectively form a multi-dimensional electromagnetic shielding structure to protect the signal terminal 220 from electromagnetic interference. In some embodiments of the present disclosure, two ground terminals 230 are respectively disposed on opposite sides of the signal terminal 220 in the horizontal direction X. The two ground terminals 230 include a plurality of micro-pin structures 235 extending along the vertical direction Y, and the ground plate 250 extends along the horizontal direction X above the two ground terminals 230 and connects to the plurality of micro-pin structures 235 of the two ground terminals 230. The two ground terminals 230, the plurality of micro-pin structures 235, and the ground plate 250 collectively surround the signal terminal 220 and provide excellent electromagnetic wave shielding effects.

In summary, the high-speed connector 100 of the present disclosure has excellent performance. The housing 110 accommodates the signal terminal 120 which provides high-speed data transmission, and the ground terminal 130 and the ground plate 150 respectively form dual ground paths to reduce electromagnetic interference and improve signal quality. In some embodiments, the ground plate 150 adopts a micro-pin structure 155 to provide high-frequency transmission. The extension arm 157 is immediately adjacent to the ground terminal 130 or disposed on the lateral side of the signal terminal 120, and the fixing arm 159 is engaged with the fastening component 190 to enhance mechanical stability and durability. This design integrates the grounding advantages and a flexible layout to ensure low noise and high signal quality, making it particularly suitable for the requirements of efficient data processing and reliable connections in modern electronic devices.

It should be understood that directional terms such as 'above' and 'below' used herein are merely for convenience of description to explain the relative positions of various components, and are not intended to limit the actual orientation in use. From different perspectives, the described 'above' and 'below' relationships may be reversed, and such variations are intended to be encompassed within the scope of the present disclosure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A high-speed connector, comprising:
a housing comprising an opening, wherein the opening defines an insertion direction;
a signal terminal accommodated within the housing;
a ground terminal accommodated within the housing and comprising a first ground path and a first ground contact point corresponding to the first ground path and the insertion direction; and
a ground plate accommodated within the housing and comprising a second ground path and a second ground contact point corresponding to the second ground path and the insertion direction, wherein the first ground contact point and the second ground contact point are spaced apart along the insertion direction.

2. The high-speed connector of claim 1, wherein the ground plate comprises a micro-pin structure, and the second ground contact point is disposed on the micro-pin structure.

3. The high-speed connector of claim 1, wherein the ground plate comprises an extension arm immediately adjacent to and disposed above the ground terminal.

4. The high-speed connector of claim 3, wherein the ground plate further comprises a micro-pin structure disposed on the extension arm.

5. The high-speed connector of claim 4, wherein the extension arm is disposed on one side of the signal terminal in a horizontal direction, and the micro-pin structure extends from the extension arm along a vertical direction.

6. The high-speed connector of claim 1, wherein the ground plate further comprises a first micro-pin structure and a second micro-pin structure, and the first micro-pin structure and the second micro-pin structure respectively extend from the ground plate along different directions.

7. The high-speed connector of claim 1, wherein the high-speed connector further comprises a fastening component, and the ground plate further has a fixing arm inserted into and fixed to the fastening component.

8. A high-speed connector, comprising:
a housing comprising an opening, wherein the opening defines an insertion direction;
a signal terminal accommodated within the housing; and
a ground terminal accommodated within the housing and comprising a first ground path, a second ground path, a first ground contact point corresponding to the first ground path and the insertion direction, and a second ground contact point corresponding to the second ground path and the insertion direction, wherein the first ground contact point and the second ground contact point are spaced apart along the insertion direction.

9. The high-speed connector of claim 8, wherein the ground terminal comprises a micro-pin structure, and the second ground contact point is disposed on the micro-pin structure.

10. The high-speed connector of claim 8, wherein the ground terminal is disposed on one side of the signal terminal in a horizontal direction, and the ground terminal comprises a micro-pin structure extending along a vertical direction.

11. A high-speed connector, comprising:
a housing comprising an opening, wherein the opening defines an insertion direction;
at least one signal terminal accommodated within the housing;
at least one ground terminal accommodated within the housing; and
a ground plate accommodated within the housing, wherein the ground plate comprises at least one first micro-pin structure and at least one second micro-pin structure, the first micro-pin structure extends away from the ground terminal, and the second micro-pin structure extends toward the ground terminal.

12. The high-speed connector of claim 11, wherein the second micro-pin structure is connected to the ground terminal.

13. The high-speed connector of claim 11, wherein the at least one second micro-pin structure comprises a row of second micro-pin structures, and the row of second micro-pin structures is disposed on one side of the signal terminal in a horizontal direction.

14. The high-speed connector of claim 11, wherein the ground plate comprises at least one extension arm adjacent to and disposed above the ground terminal.

15. The high-speed connector of claim 14, wherein the first micro-pin structure is disposed on the extension arm.

16. The high-speed connector of claim 14, wherein the extension arm is disposed on one side of the signal terminal in a horizontal direction, and the first micro-pin structure extends from the extension arm along a vertical direction.

17. The high-speed connector of claim 11, wherein the at least one ground terminal comprises two ground terminals, and the two ground terminals are disposed on opposite sides of the signal terminal in a horizontal direction.

18. The high-speed connector of claim 17, wherein the ground plate comprises two extension arms respectively adjacent to and disposed above the two ground terminals, and the at least one first micro-pin structure comprises two first micro-pin structures respectively disposed on the two extension arms.

19. The high-speed connector of claim 17, wherein the at least one second micro-pin structure comprises two rows of second micro-pin structures, and the two rows of second micro-pin structures are respectively disposed on opposite sides of the signal terminal in a horizontal direction.

20. The high-speed connector of claim 19, wherein the two ground terminals, the ground plate, and the two rows of second micro-pin structures collectively surround the signal terminal.
